(19) United States
(12) Patent Application Publication
(10) Pub. No.: US 2018/0128467 A1
(43) Pub. Date: May 10, 2018

(54) POWER BAR HANGER FOR MODULAR LIGHTING SYSTEM

(71) Applicant: Robert A. Sonneman, Mamaroneck, NY (US)

(72) Inventor: Robert A. Sonneman, Mamaroneck, NY (US)

(21) Appl. No.: 15/447,660

(22) Filed: Mar. 2, 2017

Related U.S. Application Data
(63) Continuation-in-part of application No. 29/587,568, filed on Dec. 14, 2016, now Pat. No. D791400.
(60) Provisional application No. 62/419,505, filed on Nov. 9, 2016.

(51) Int. Cl. F21V 21/35; F21S 8/06; F21S 2/00; F21V 21/104; F21V 23/02

(52) U.S. Cl. CPC F21V 21/35; F21S 8/063; F21V 23/02; F21V 21/104; F21S 2/005

(57) ABSTRACT

A hanger for supporting the ends of two in-line power bars includes a body two cavities receiving the respective ends of the power bars. Clips within the cavities engage rails in the power bars. One or more rods support the body and can also be connected to the clips.

### RELATED APPLICATION

This application claims priority to U.S. Provisional Application Ser. No. 62/419,505 filed Nov. 9, 2016 and is a continuation-in-part of U.S. design application Ser. No. 29/587,568 filed on Dec. 14, 2016, all incorporated herein by reference in their entirety.

### BACKGROUND OF THE INVENTION

### A. Field of Invention

This invention pertains to a connector interconnecting two power bars in a modular lighting systems. The connector supports the ends of the power bars and can be used to support the power bars and, optionally, to provide power thereto.

### B. Description of the Prior Art

Designing lighting for a space has always been an interesting challenge because the lighting equipment has to meet utilitarian, technical and esthetic needs. Thus, any such endeavor is successful only if combining technical, architectural and artistic skills.

Several different types of ceiling lights are presently available, including surface mounted lights, recessed lights and hanging lights. The present invention pertains to hanging lights.

### SUMMARY OF THE INVENTION

Briefly, a modular lighting system for providing light in a space includes canopies connectable to a power source; a plurality of horizontal bars; a plurality of hangers, including a first set of hangers supporting bars from said canopy and a second set of hangers, each said hangers including a first end disposed between and engaging said bar segment. The system further includes a plurality of pendants supported by the second set of hangers from the bars. The hangers and bars cooperate to provide electric power to said pendants from said canopy.

Preferably, each bar includes two bar segments facing each other and being made of a non-conductive material. Conductive rails are provided on the inner surface of each bar segment. The hangers include a base configured to form an interference fit with the bar segments. In one embodiment, the hangers include two conductive parallel rods or cables that are in electrical contact with the rails through the respective bases.

These various elements are combined in many different ways resulting in a virtually infinite number of configurations. One class of configuration may include several bars disposed in a vertical plane. In another class of configurations, several bars extend at different angles in one plane, and are joined at a common point. Another class of configurations may include a combination of the first to classes. Another class of configurations may include several bars disposed at different heights or tiers, some bars being perpendicular to other bars.

Preferably, in accordance with this invention, a hanger is provided for hanging and interconnecting simultaneously the ends of two power bars. The power bars are oriented in line with each other by the hanger. The hanger is formed with a body defining two cavities receiving the respective ends of the power bars.

Clips are provided within the cavities and they engage and form an interference fit with respective rails within the power bars. Optionally, the clips of one cavity are connected to clips of the other cavity by respective connecting elements buries in the body, and thereby providing electrical connection between the power bars.

In one embodiment, a rod extends upward from an inner wall separating the two cavities. The rod is electrically insulated from the clips.

In another embodiment, two rods extend upwardly from body and are electrically connected to the clips. The power can be provided either through one of the power bars to the hanger or from the two rods.

### DESCRIPTION OF THE DRAWINGS

FIG. 1 shows an orthogonal view of a modular lighting system;

FIG. 2 shows an orthogonal view of another modular lighting system;

FIGS. 3A-3K shows details of a power bar used in the system if FIG. 1 or FIG. 2;

FIGS. 4A-4J show details of hangers used in the system of FIG. 1 or FIG. 2;

FIGS. 5A-5E show details of a hanger used for supporting the power bars; and

FIGS. 6A-6C show details of an alternate embodiment for the hanger of FIGS. 5A-5E.

### DETAILED DESCRIPTION OF THE INVENTION

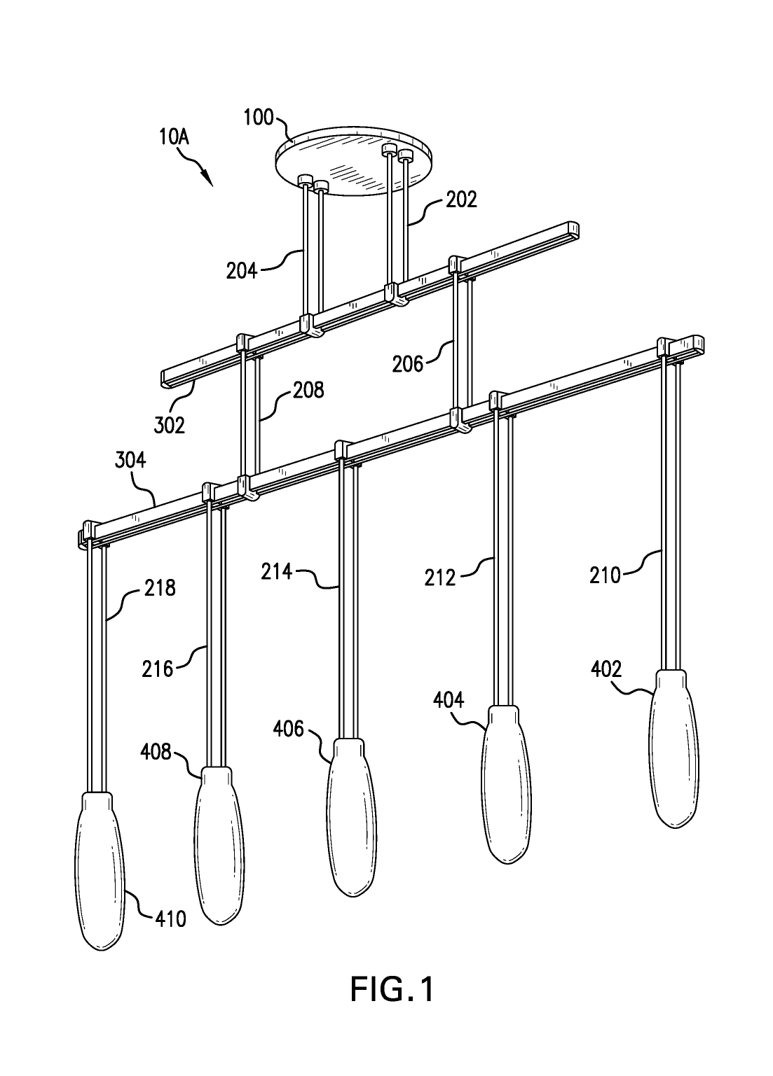

FIG. 1 show the elements of modular lighting systems constructed in accordance with this invention. Generally speaking, each system includes one or more canopies 100, a plurality of hangers 200, a plurality of power bars 300 and a plurality of pendants 400. In addition, some systems may also include optional connectors 500.

Unless otherwise noted, all the hangers and all power bars consist of two interconnected elements.

In the FIG. 1, system 10 includes a canopy 100 that supports the system from a ceiling or other similar architectural member in a conventional manner. In this case, the canopy 100 also provides power to the system. Other, more complicated systems may have several canopies provided for support and only some or only one canopy may also provide power. Canopy 100 includes a conventional power supply connected to standard AC lines for providing power to the LED tubes in the pendants as discussed below. The power supply is hidden.

Two hangers 202, 204 extend downwardly from the canopy. In one embodiment, each hanger discussed hereinafter consists of two solid bars or rods. These hangers are termed the power feed hangers. In an alternate embodiment the hangers are replaced by multi-strand twisted steel cables.

In FIG. 1 the hangers 202, 204 are used to support a power bar 302. Two hangers 206, 208 are used to support a second power bar 304. These hangers are termed the power bar hangers.

Another set of hangers 210-218 are used to support a plurality of pendants 402-410. These hangers are termed pendant hangers. The pendants 402-410 preferably include LED bulbs running on 24 VAC

Preferably, one of the power feed hangers, e.g., hanger 202 has its two hanger segments connected to a transformer disposed within the canopy 100. The transformer steps down the line voltage from a standard power line to 24 VAC for the pendants 402-410. The other hanger 204 may be electrically floating. The power from the hanger 202 flows through the bar segments of bar 302, hanger 206, bar 304 and hangers 210-212 to the pendants. Thus, in this embodiment, only some of the pendants carry power but all the power bars do.

Two different kinds of power bar hangers are provided: parallel hangers for hanging one power bar beneath another, wherein the two power bars extend in parallel. Perpendicular hangers are used to support one power bar from the other wherein the two bars are running perpendicular two each other as described in more detail below.

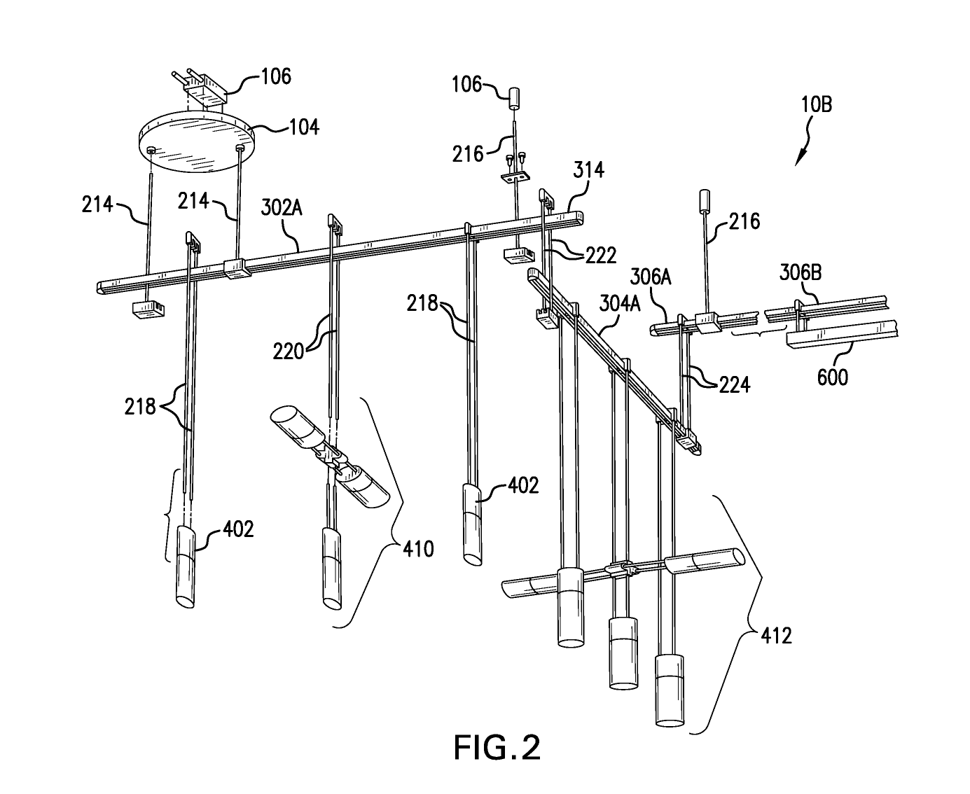

FIG. 2 shows yet another system 10B. This system 10B includes a canopy 104 with a transformer 106. Attached to the canopy 104 is a first bar 302A using two hangers 214. As opposed to the hangers discussed previously, hangers 214 have a single extended element, such as a rod. Each of the hangers 214 provides power to one of the elements of bar 302A. However because the bar 302A is not centered below the canopy 104 but extends in one direction away therefrom. Another hanger 216, which may be referred to as a ceiling hanger, is used to support a distal end 314 of bar 302. At its top, hanger 216 is attached to a sleeve 106 secured to the ceiling in a conventional manner.

Hangers 218 are used to attach respective pendants 402 from bus 302. Another hanger 220 is used to support a cluster of pendants 410.

A second bar 304A is also provided. This bar 304A is supported at one end by a hanger 222 from bar 302A. This hanger 222 also provides power to bar 304A. A third bar 306 is also provided that is supported from the ceiling by ceiling hangers 216 (only one such ceiling hanger is being shown for the sake of clarity). Bar 306 supports the second end of bar 304A and receives power from said bus 304 through hanger 224. Each of the bars 302A, 304A, 306A can be used to hang pendants of various sizes and shapes and arranged in different configurations as desired.

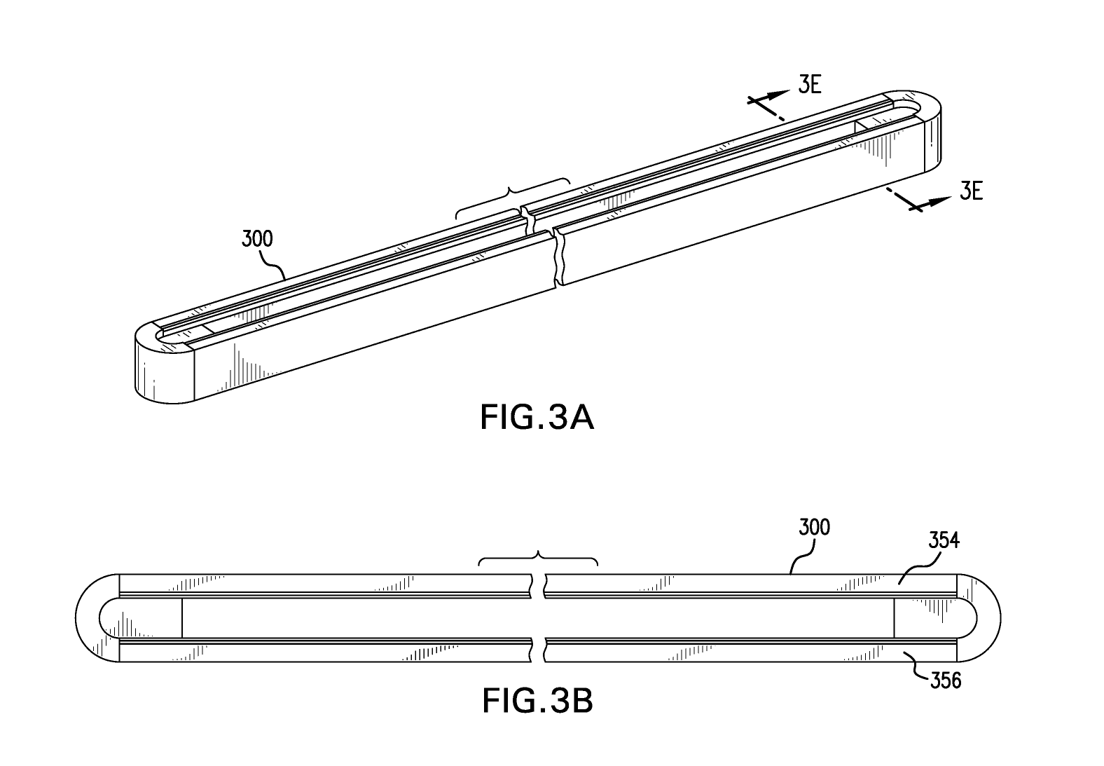

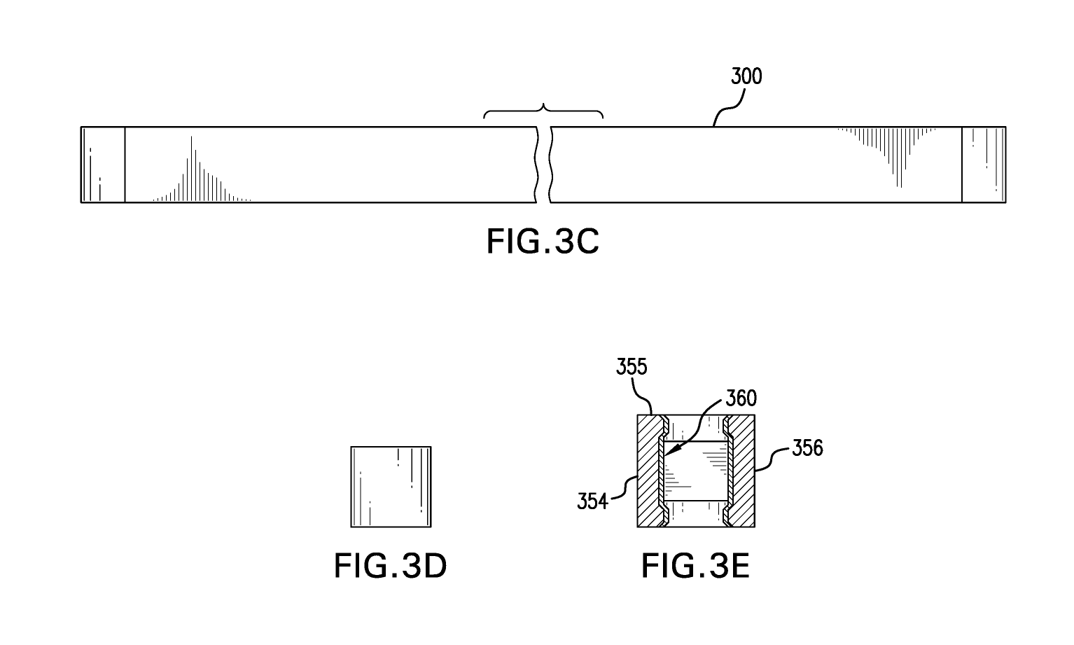

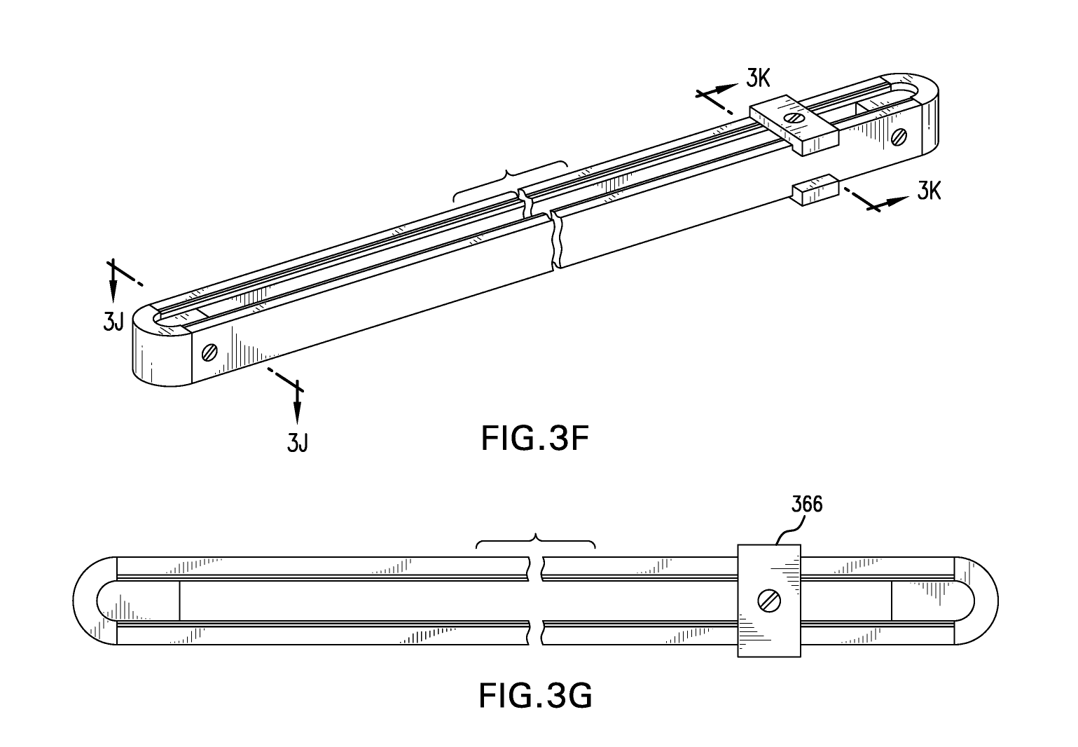

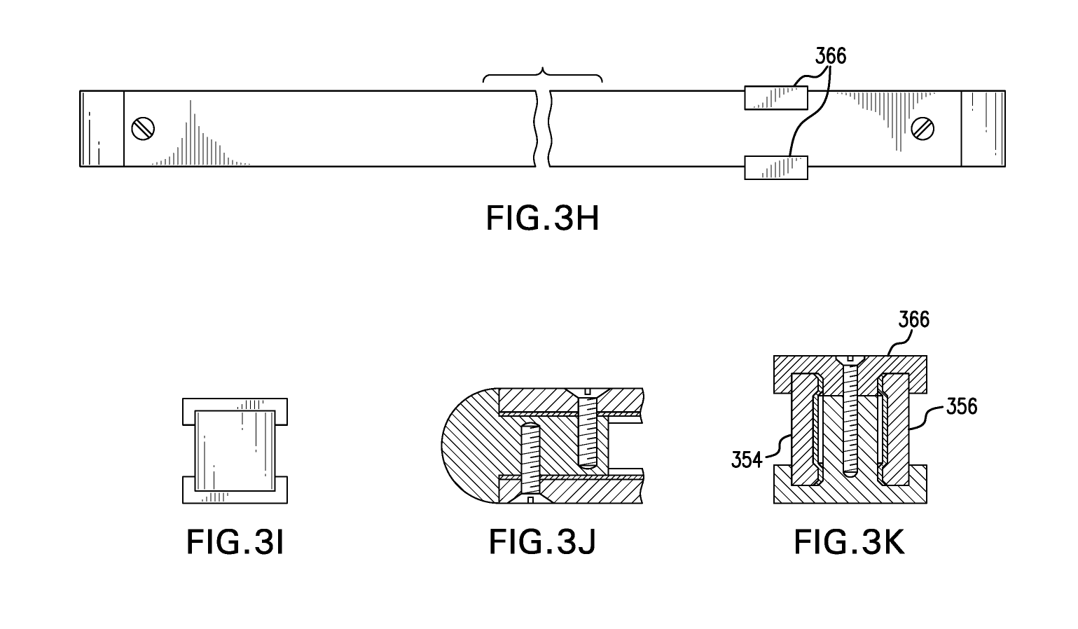

Details of a generic bar 300 are shown in FIGS. 3A-3K. Unless otherwise noted, all the bars discussed here have the same configuration. In this Figure, bar 300 is shown as being straight however, it can be circular ellipsoid or can have other geometric shape. The bar 300 includes two identical longitudinal segments 352, 354 facing each other. A cross-sectional view of segment 354 is seen in FIG. 3B. Segment 354 is formed of a C-shaped main body 355 made of a non-conductive material, such as a plastic material that is light weight but strong so that it can support various pendants, other bars, etc. Imbedded in this main body 355 is a rail 356 made of a light weight conductive material such as aluminum. Preferably rail 356 is formed with a rectangular channel 360. The two segments 352, 354 are joined together at the two ends by end connectors 362. The connectors 362 are attached to the bars by conventional means, such as screws 364, by an adhesive or other means.

Preferably, the two segments 352, 354 have inner surfaces spaced at a nominal distance d throughout the length of the bar 300. The bar 300 is made in standard lengths ranging from to 12 to 48 inches. For very long bars, for example in excess of 24 inches, a spacer 366 is placed between the segments. The spacer 366 may be held in place by screws or other means.

There are several different types of bar hangers are provided: hangers for supporting bars from canopies, hangers for supporting bars from ceilings (without a power connection), hangers for supporting one bar from another bar and hangers for supporting pendants. All these hangers have must be able to interface with a bar at least at one end as described below.

There are two types of bar-to-bar hangers: parallel hangers for connecting two parallel bars and perpendicular hangers connecting two bars running perpendicular two each other.

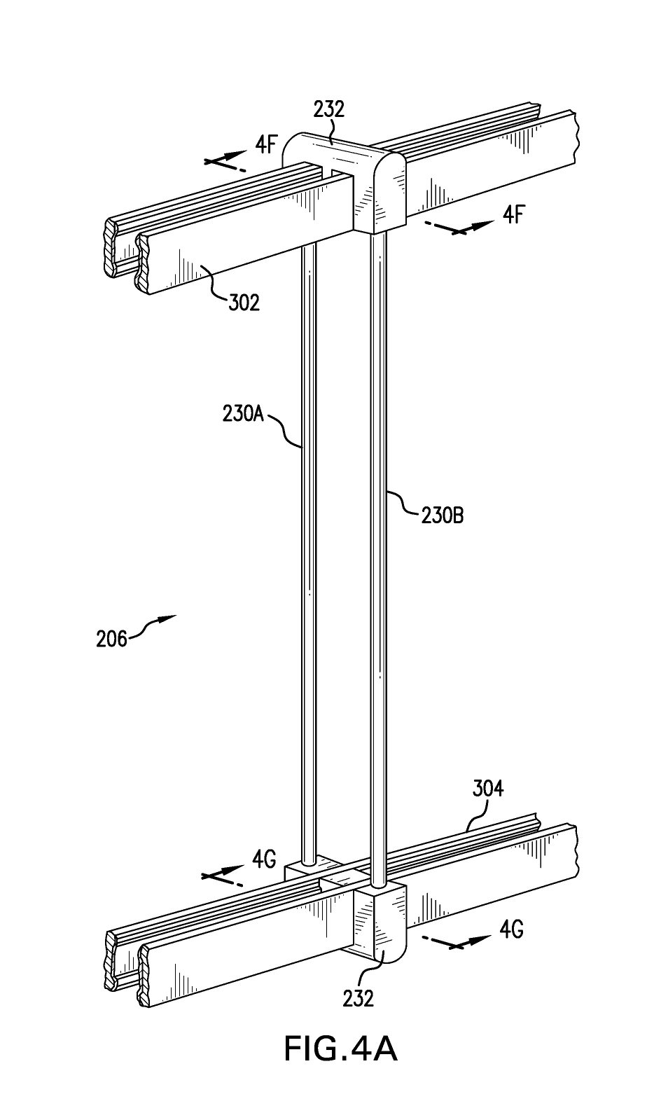

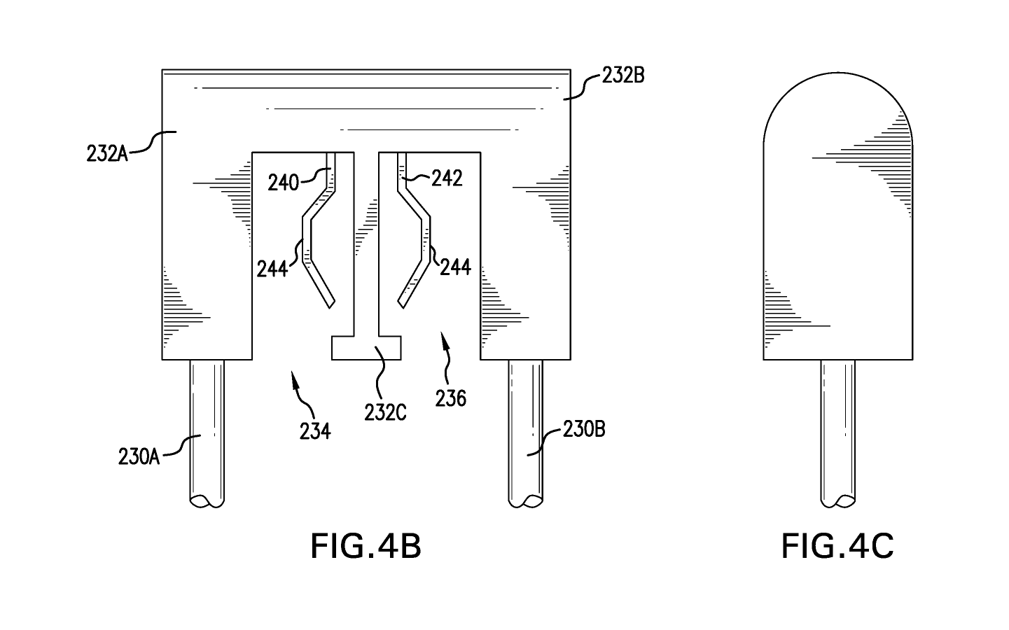

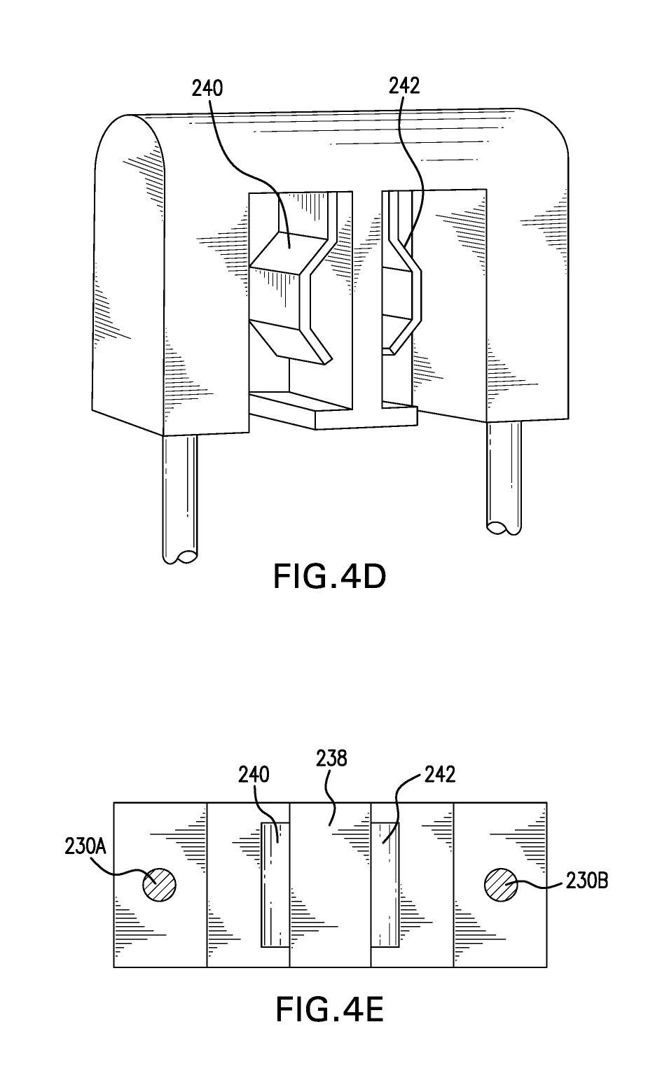

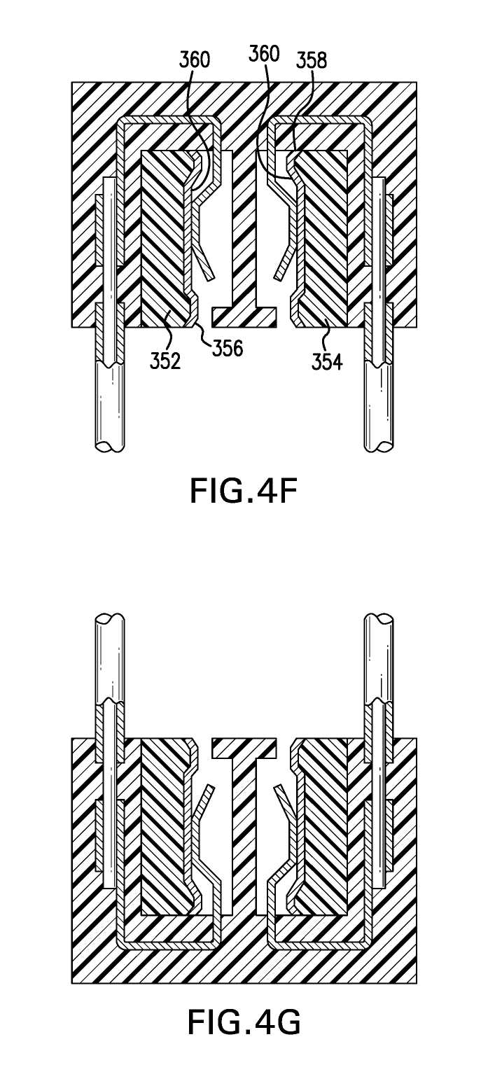

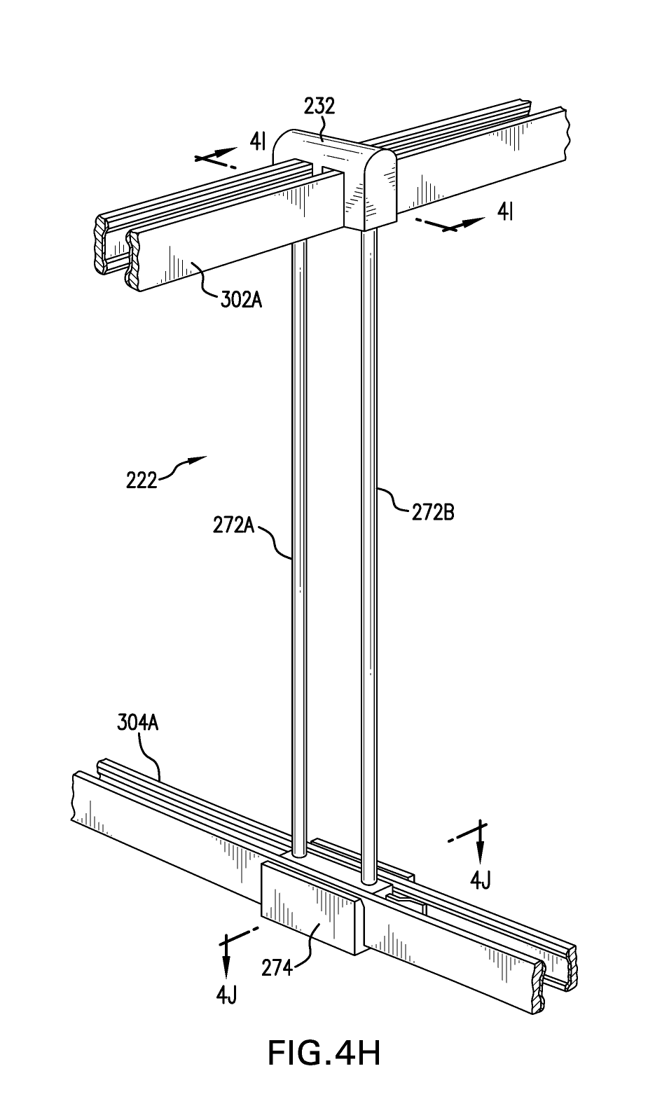

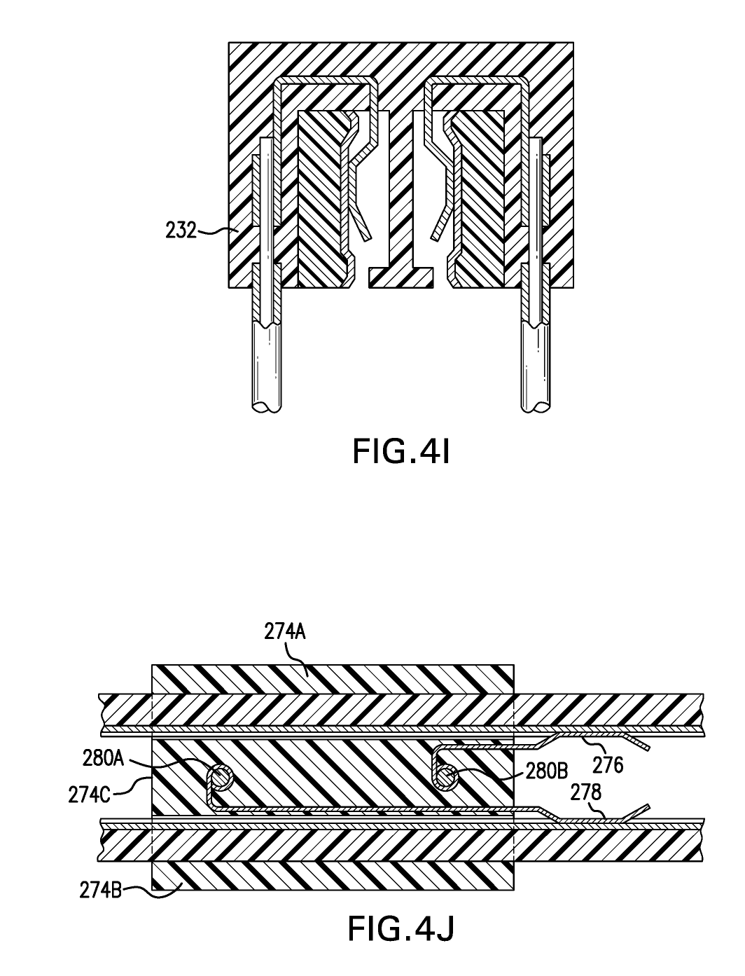

FIGS. 4A-4G show details of parallel bar hanger such as hanger 206 supporting bar 304 from bar 302 in FIG. 1. The hanger 206 includes two vertical segments 230A, 230B. At the top and the bottom, the two segments 230A, 230B have their ends imbedded in identical W-shaped bases 232, shown in more detail in FIGS. 4B-9E. The base 232 forms two channels 234, 236 with a wall 238 separating the two channels. The base 232 is further formed with two metallic springs or clips 240, 242. Clip 240 is electrically attached to segment 230A within the base 232, and clip 242 is connected to segment 230B. Preferably, base 232 is made of a non-conductive material and is overmolded to cover portions of the clips 240, 242 and segments 230A, 230B. In one embodiment, the two bases 232 have a single, unitary structure. In another embodiment, at least the top base is made of two sections 232A, 232B that snap together along line 232 forming an interference fit therebetween.

As can be seen in FIGS. 4F and 4G, the bases 232 as sized and shaped so that they fit over and engage the bars 302, 304. Importantly, the clips 240, 242 are sized and shaped so that they engage the rails 356, 358. The clips 240, 242 have a flat section 244 sized and shaped to snap into the channels 356, 358 of the bars 302, 304. In this manner not only do the clips 240, 242 provide a solid electrical contact with the rails 356, 358 but they also stabilize the hangers on the bars and insure that the lower bar 304 remains stiff and does move around in use. The clips may be made from beryllium copper.

Hanger 208 has a similar configuration however the clips need not be connected electrically to the hanger segments. In other cases, for example, in the configuration shown in FIG. 2, hangers 222 do provide electrical connection to bars 304A and 306A.

The hanger segments 230A, 230B are provided in various lengths as required to obtain the various systems described above, and they are preferably made in the shape of rods of a stiff but somewhat springy material having shape memory such as a phosphor/bronze alloy. Preferably except where an electrical contact is required, the rods are covered or painted with a thin electrically insulating material.

The hangers can be installed by separating the two segments 230A, 230B, passing the ends of the respective bars 302, 304 . . . between the segments, then lowering or raising the bars toward the respective bases 232 and then snapping the bases onto the bars into the configurations shown in FIGS. 4F and 4G.

As discussed above, and illustrated in more detail below, in some instances, the power bars extend perpendicularly to each other. For example, in FIG. 2, bars 302 and 304 are perpendicular to each other. These bars are interconnected using a hanger 222 shown in FIGS. 4H-4J. This hanger 222 has two segments 272A, 272B and a base 232 similar to the base 232 in FIGS. 9A-9G. However, at the bottom hanger 222 is provided with a different base 274. This base 274 is formed with two side wings 274A, 274B and a center wall 274C. Clips 276, 278 are provided on the center wall 274C and are connected electrically with segments 272A, 272B, respectively as show in FIG. 4J. The center wall 274C is made with two holes 280A, 280B with the lower ends of segments 272A, 272B extending into the holes and being secured to the base 222. The base 270 is sized and shaped to engage and support the power bar segments 304A, 304B of a bar 304A with the segments 272A, 272B providing power to these power bar segments. The base 232 engages the segments of the bar 302 in the manner discussed above.

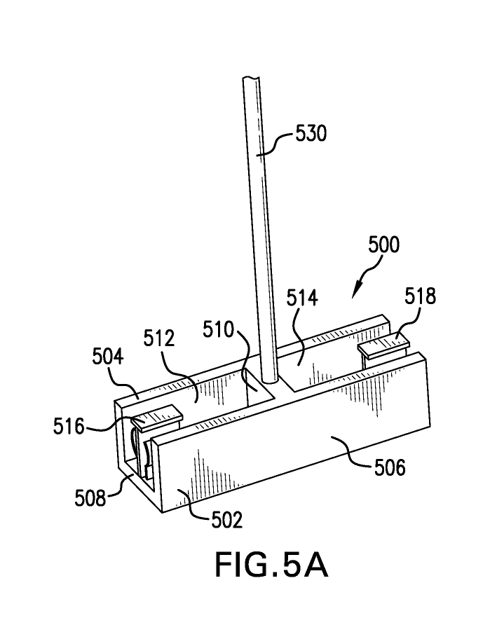

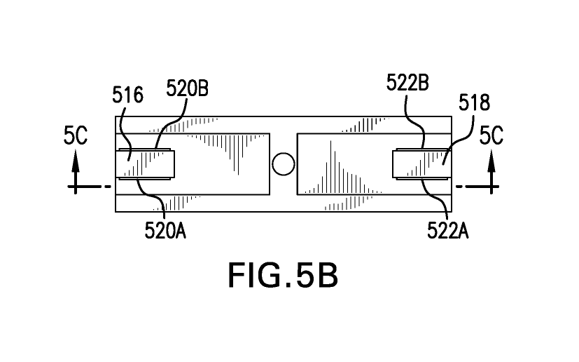

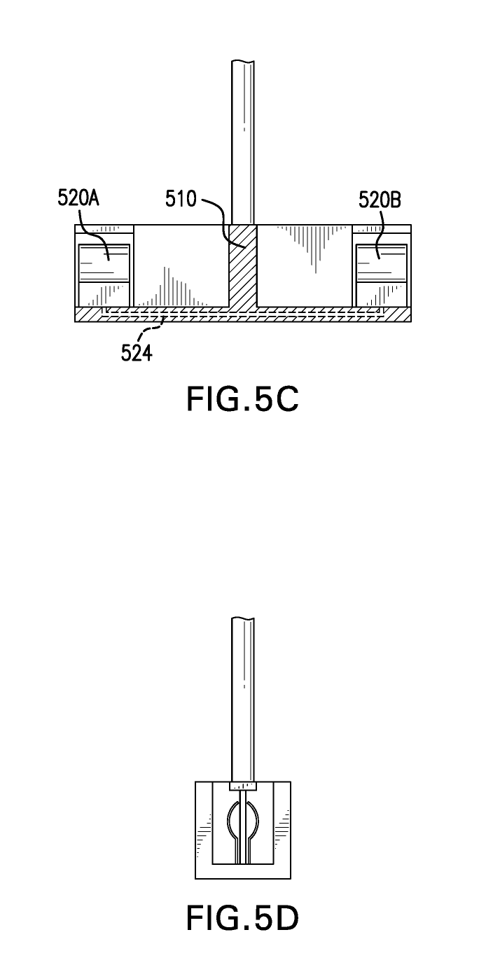

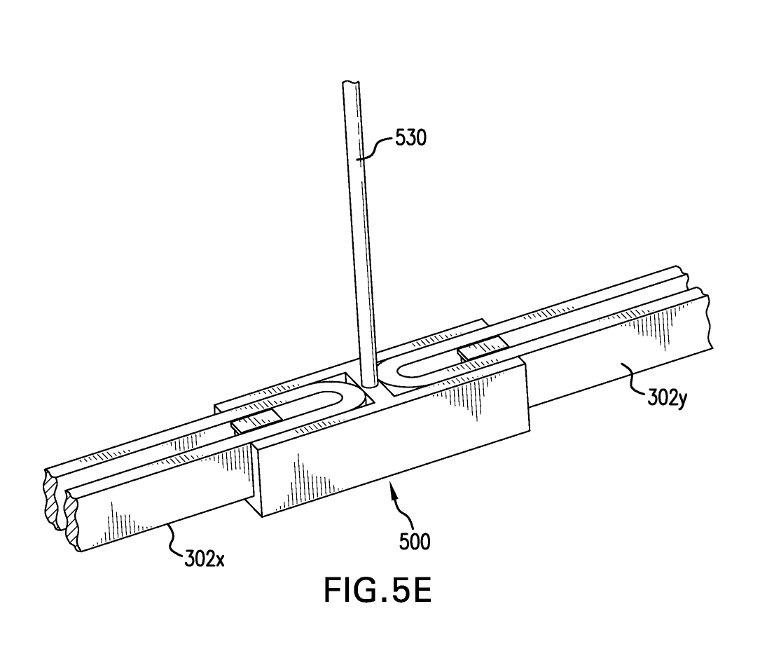

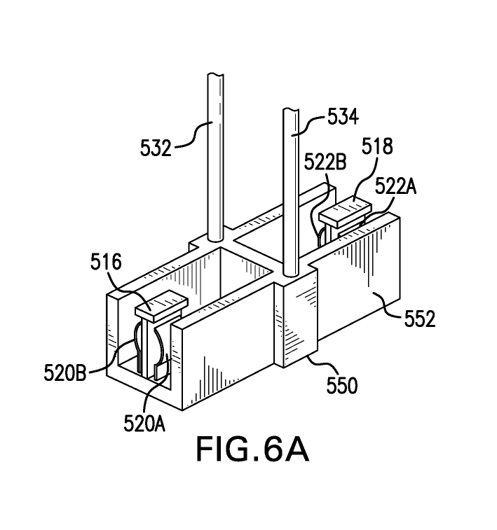

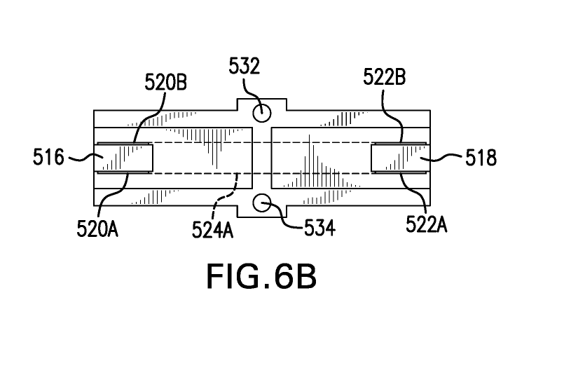

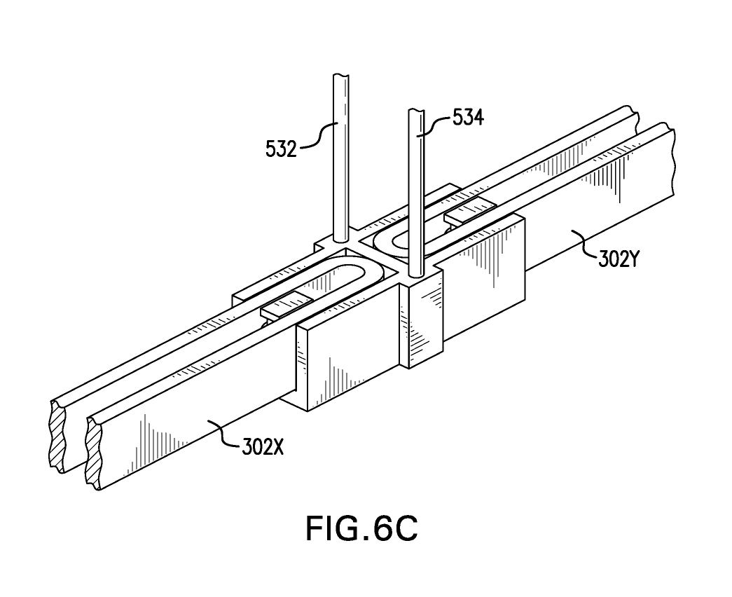

In the embodiments discussed above, the various power bars within a system configuration can be disposed at separate heights and may be supported by different hangers. The hangers of FIGS. 5A-5E, 6A-6C are used to support and at least mechanically interconnect the respective ends of two power bars disposed at the same height. In the embodiment of FIGS. 5A-5E, a hanger 500 is provided having a body 502 with two outer walls 504, 506 and a bottom wall 508. The body 502 is also formed with an interior wall 510 extending between walls outer 504, 506 to divide the space between these outer walls into two cavities 512, 514. Two additional interior walls 516, 518 are attached to bottom wall 508 and extend vertically into the cavities 512, 514 respectively. Electrical clips 520A, 520B are provided on opposite sides of wall 516, and clips 522A, 522B are provided on opposite sides of wall 518. These clips 520A, 520B, 522A, 522B have the same size and shape as the clips of the previously described hangers, such as clip 240 in FIG. 4B. These clips may be electrically isolated from each other. Alternatively, clips 520A, 522A may be electrically connected by a conductive element 524 preferably imbedded in body 502. A similar conductive element (not shown) is used to connect clips 520B and 522B.

A rod 530 is attached to the wall 510 and extends upwards as shown. IN the embodiment of FIGS. 5A-5E the rod 530 is not electrically connected to any other element of the lighting system.

The hanger 500 is used to support simultaneously the respective ends of two bars 302X, 302Y in line as shown in FIG. 5E. The bars 302X, 302Y have the structures shown in FIGS. 3A-3K. The bars 302X, 302Y are snapped into the cavities 512, 514 with the clips 520A, 520B, 522A, 522B mechanically engaging the rails 360 of the power bars 302X, 302Y. If these clips are isolated, the hanger 500 provides only mechanical support for the ends of the power bars 302X, 302Y. If the clips are interconnected electrically, then they also provide electrical connection between the bars. The rod 530 can extend to another bar, to a canopy or some other structure to support the body 502.

FIGS. 6A-6C show a hanger 550 having a structure similar to the hanger 500. The hanger 550 includes a hanger body 552 supported by two rods 532, 534. The body 552 further includes interior walls 510, 516, 518 and clips 520A, 520B, 522A, 522B.

The clips 520A, 522A are electrically connected by a first conductor element 524A and clips 520B, 522B are electrically connected to a second conductor element 524B. Importantly, as shown diagrammatically in FIG. 6B, the conductor elements 524A, 524B are also connected to rods 534, 532 respectively. As a result, when the ends of bars 302X, 302Y are snapped into the cavities 514, 516, electrical connection is established not only between the power bars 302X, 302Y but also between these bars and the rods 532, 534. The rods 532. 534 can be connected to a canopy, such as canopy 100 in FIG. 1 or to another power bar using for example one of the hangers of FIG. 4F. As a result power is provided from the rods 532, 534 to both power bars 302X, 302Y. Alternatively, power can be provided from one of the power bars, e.g., power bar 302X to power bar 302Y and rods 532, 534.

Numerous modifications may be made to this invention without departing from its scope as defined in the appended claims.

What is claimed is:

1. A hanger for supporting the respective ends of two power bars of a lighting system, each said power bar including two rails arranged and constructed to deliver power to pendants, said hanger comprising:
a body forming a first cavity arranged to receive the end of one of the power bars and a second cavity arranged to receive the end of the other of said power bars;
a first set of clips disposed in said first cavity and arranged and constructed to form an interference fit with the rails of the first bar;
a second set of clips disposed in said cavity and arranged and constructed to form an interference fit with the rails of the second bar; and
a rod attached to and extending upwardly of said body.

2. The hanger of claim 1 further comprising at least one connector element connecting electrically one of said first set of clips to one of said second set of clips.

3. The hanger of claim 1 further comprising an inner wall between said first and second cavities, with said rod extending from said inner wall.

4. The hanger of claim 1 further comprising a first inner wall disposed in said first cavity and a second inner wall disposed in said cavity, said first set of clips being attached to said first inner wall and said second set of clips being attached to said second inner wall.

5. The hanger of claim 1 wherein said first and second set of clips are electrically insulated.

6. A hanger for supporting the respective ends of a first and a second power bar, the power bars disposed in line and supporting and providing power to pendants of a modular lighting system, the power bars including two longitudinal rails and respective power bar ends, the hanger comprising:
a body forming a first cavity sized and shaped to receive the end of the first power bar and a second cavity sized and shaped to receive the end of the second power bar, a first inner wall disposed in said first cavity, and a second inner wall disposed in said cavity, said inner walls having opposed sidewalls;
a first set of clips disposed on said opposed sidewalls of said first inner wall;
a second set of clips disposed on said opposed sidewalls of said second inner wall; and
a rod extending upward and arranged to support said body.

7. The hanger of claim 6 wherein said clips are electrically insulated from each other.

8. The hanger of claim 6 further comprising a first connecting element connecting a clip of said first set to a clip of said second set.

9. The hanger of claim 8 further comprising a second connecting element connecting another clip of said first set to another clip of said second set.

10. The hanger of claim 8 wherein said rod is electrically connected to one of said clips.

11. The hanger of claim 8 wherein said rod is electrically connected to said first connecting element.

12. The hanger of claim 9 further comprising a second rod electrically connected to said second connecting element.
